(19) United States
(12) Patent Application Publication
(10) Pub. No.: US 2025/0010205 A1
(43) Pub. Date: Jan. 9, 2025

(54) System and Method for Efficient Matching of Players in Virtual Games

(71) Applicant: Galactus Funware Technology Private Limited, Bengaluru, Karnataka (IN)

(72) Inventors: Izzatbir SINGH, Patiala (IN); Aashay SACHDEVA, Ghaziabad (IN); Rishi SWAMI, Bengaluru (IN); Kabir RUSTOGI, New Delhi (IN)

(21) Appl. No.: 18/548,389

(22) PCT Filed: Jun. 28, 2023
(86) PCT No.: PCT/IB2023/056690

§ 371 Date: Aug. 30, 2023

(30) Foreign Application Priority Data
May 9, 2022 (IN) 202241026756

(51) Int. Cl. A63F 13/795

(52) U.S. Cl. CPC A63F 13/795

(57) ABSTRACT

Disclosures of the present invention relate to a system and method of intelligently matching players intending to play a multiplayer online game. The system in the present invention stores data of players which is then used to compare between players and select matches. The data corresponds to player's statistical parameters as well as historical and demographic data. Further, the system is configured to dynamically adjust matchmaking objectives by modifying the parameters to select and the weightage for individual parameters. Hence, the improved system and method is capable of matching players in games that are challenging, engaging as well as fun to play for the players.

### FIELD OF INVENTION

Embodiments of the disclosure relate generally to the field of matching players in multiplayer online gaming systems. More particularly, embodiments of the disclosure relate to a method and system for improving efficiency while matching players in multiplayer online gaming.

### BACKGROUND

With the growing number of people having access to computers and mobile devices, virtual games are becoming more widespread, especially among the younger generation.

It is imperative for game developers and gaming platforms to develop engaging games as well as create enjoyable experiences for their players. A major part of creating such experiences is the aspect of match composition.

Match composition or the process of matchmaking decides the players that are to be played together in a single instance of a game. Typically, matchmaking is accomplished by selecting the first available player(s) or through random matching. More recently, advanced matchmaking techniques have been developed that take into account the player's skill level, demographic data, connection quality, waiting time, among others.

One particular parameter is the player's skill level which is typically used to create matches that are challenging and evenly balanced. Various techniques exist for calculating the skill level of players, one of which is the prominently used ELO ranking. The ELO ranking system takes into account the rank difference between the players and updates the ranks by awarding different points for a win, loss or a draw.

However, such systems which rely on skill levels may not be dynamically adjustable to cater to the changing preferences and scenarios. Furthermore, such systems may not be able to create matches where the focus is engagement and fun for the players.

A need, therefore, arises for a method and system for intelligently matching players in games that are challenging, engaging as well as fun to play for the players.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention provides for a method of matching players requesting to play a virtual game. The method comprises of steps to receive a first request from a first player where the request signals an intent of the first player to play the virtual game; a step of identifying a first game type from the first request; and a step of selecting at least one parameter from a list of parameters, corresponding to the identified game and where the list of parameters corresponds to historical records of players playing the virtual game.

Further, the method includes a step of identifying a weightage factor for the at least one parameter; a step of identifying a second request made by a second player received asynchronously from the first request; accessing player data values corresponding to the at least one parameter for the first player and the second player and combining player data values corresponding to the at least one parameter for the first player with those of the second player to yield a matching score, wherein the combination is a weighted combination using the weightage factor for the at least one parameter.

Further, the present invention provides for a system of matching players requesting to play a virtual game. The system comprises of one or more processing modules; one or more data storage modules, operatively coupled to the one or more processing modules.

Further, the one or more data storage modules are configured to store at least one of a list of parameters corresponding to historical records of players playing the virtual game where player data values correspond to the list of parameters. The data storage modules further store at least one memory module operatively coupled to the one or more processing modules.

Further, the at least one memory module stores instructions which, when executed by the one or more processing modules, causes the one or more processing modules to, identify a game type from a first matchmaking request made by first player; select at least one parameter from a list of parameters, corresponding to the identified game type.

Further, the system identify a weightage factor for the at least one parameter; identify a second request made by a second player; access player data values corresponding to the at least one parameter for the first player and the second player; combine player data values corresponding to the at least one parameter for the first player with those of the second player to yield a matching score, wherein the combination is a weighted combination using the weightage factor for the at least one parameter. It is an object of the invention to provide improved method and system for matching players intending to play a multiplayer online game.

Also, it is an object of the invention to provide improved method and system for intelligently matching players that is adaptive and dynamically adjustable.

It is further an object of the invention to provide improved method and system for intelligently matching players in games that are challenging, engaging as well as fun to play for the players.

The independent claims define the invention in various aspects. The dependent claims state selected elements of embodiments according to the invention in various aspects.

This summary is submitted with the understanding that it will not be used to interpret or limit the scope or meaning of the claims. This summary is not intended to identify key features or essential features of the claimed subject matter, nor is it intended to be used as an aid in determining the scope of the claimed subject matter. Other methods, apparatus and systems are also disclosed. Those skilled in the art will recognize additional features and advantages upon reading the following detailed description, and upon viewing the accompanying drawings.

### BRIEF DESCRIPTION OF DRAWINGS

Embodiments according to the claimed subject matter are described below with reference to the drawings. The detailed description references the accompanying figures. The same numbers can be used throughout the drawings to reference like-features and components. As used herein, like terms refer to like elements throughout the description. It should be noted that views of exemplary embodiments are merely to illustrate selected features of the embodiment. The views qualitatively illustrate exemplary features of some embodiments and, therefore, should not be interpreted as being drawn to scale.

FIG. 1 is a block diagram schematically showing an exemplary gaming architecture according to some implementations of the present invention.

FIG. 2 is a block diagram schematically showing an exemplary configuration of the central gaming system 101 according to some implementations of the present invention.

FIG. 3 is a flowchart showing a method of generating intelligent matches, according to some implementations of the present invention.

### DETAILED DESCRIPTION

For purposes of explanation, numerous specific details are set forth in order to provide a thorough understanding of the claimed subject matter. It may be evident, however, that the claimed subject matter may be practiced without these specific details. Also, in some instances, well-known features are omitted or simplified to clarify the description of the exemplary implementations. In some other instances, well-known features or units or circuits have been shown in block diagram form in order to avoid clutter due to unnecessary detailing.

Reference will now be made to the drawings to describe the present invention in detail. The implementations herein are described in terms of exemplary embodiments. However, it should be appreciated that individual aspects of the implementations may be separately claimed and one or more of the features of the various embodiments may be combined.

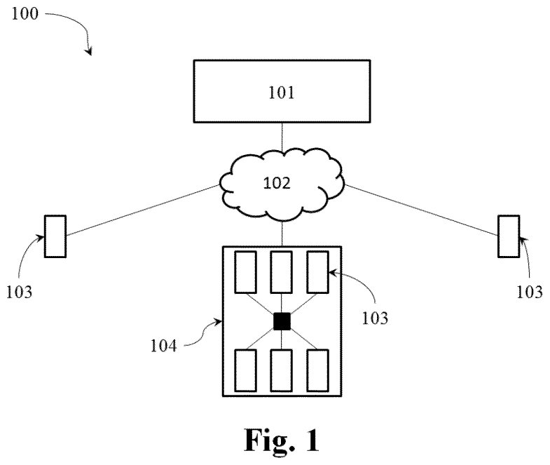

FIG. 1 is a block diagram schematically showing an exemplary gaming architecture according to some implementations of the present invention. The gaming architecture 100 may include a central gaming system 101 and a communications network 102.

The communications network 102 may be any wired and/or wireless network such as internet, WWW, local or wide area network, satellite communication network, Ethernet, PSTN, radio communication network or any such wired and/or wireless communication networks well known in the art. The communications network 102 may also be a combination of such known networks.

The central gaming system 101 may communicate with plurality of gaming terminals through the communications network 102. The gaming terminals may be player terminals 103. Alternatively, or in addition, the gaming terminals may be local gaming systems 104, which are connected, wired or wirelessly, to player terminals 103.

The player terminals 103 may include, but not limited to, mobile phones, desktops, laptops, tablet computers, handheld devices, dedicated gaming consoles, or the like. The local gaming system 104 may facilitate communication between the player terminals 103 and the central gaming system 101. Alternatively, or in addition, the local gaming systems 104 may administer the games, track game data, player data, regulations data, track or manage financial transactions, and/or may serve any such ancillary functions. The local gaming systems 104 may be configured to serve locations such as airports, educational institutions or gaming convention canters etc.

It is to be appreciated here that the gaming architecture 100 is merely exemplary of a number of possible gaming network configurations, without limiting or deviating from the scope of the invention.

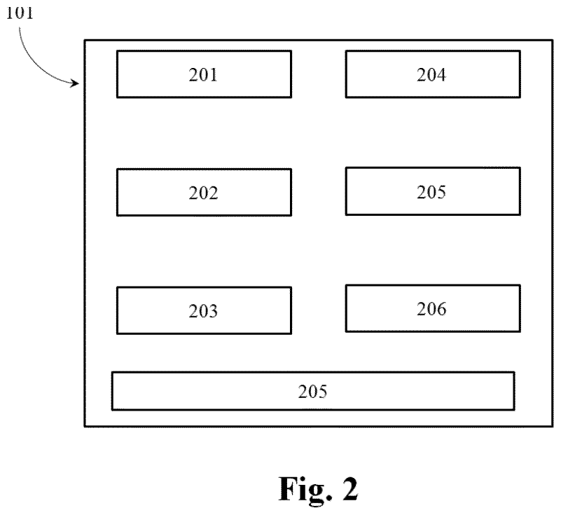

FIG. 2 is a block diagram schematically showing an exemplary configuration of the central gaming system 101 according to some implementations of the present invention.

The central gaming system 101 may include one or more processor modules 201, one or more data storage modules 202, one or more input/output modules 203, one or more memory modules 204, one or more networking interface 205, one or more internal networking module 206, and/or at least one matchmaking module 207.

It is to be appreciated by those skilled in the art that although FIG. 2 shows the various components of the central gaming system 101 as co-located, such components may be distributed geographically without deviating from the scope of the invention. Further, the central gaming system 101 according to some other implementations of the invention may include different components and/or configuration than those shown herein. Still further, the different components as shown here are merely functional components, and therefore, such functions may be performed by an integrated module, without deviating from the scope of the invention. In the same spirit, it is to be appreciated by those skilled in the art that different components as shown in FIG. 2 may employ shared resources, such as shared processor, memory, communications, networking or the like.

One or more processor modules 201 may be configured to run various algorithms, computer programs, gaming applications or other applications or programs to facilitate operations of the gaming architecture 100.

One or more data storage modules 202 may be configured to store gaming software and programs. Such gaming software and programs facilitate operations and execution of various virtual games. One or more data storage modules 202 may also store player data, including but not limited to, player IDs and demographic details. Further, one or more data storage modules 202 may store login and fingerprinting data for player terminals 103. The login and fingerprinting data may be used to identify the player terminals 103 through various parameters such as type, make and/or configuration, physical location, virtual location (for instance, IP address), OS version, or the like.

Additionally, one or more data storage modules 202 may be configured to store play data, including game profiles and player profiles. A game profile may include all data relevant to a particular game, such as, but not limited to, number of game instances, total time and/or time per game, scorecards, in-game moves, game modes, number or percentage of players playing the game, and so on and so forth. The game profiles may also include real-time or near real-time data generated during live execution of virtual games.

A player profile may include all data arising out of a player's interaction with the central gaming system 101; such data indicative of the player's performance, skill, activity, preferences, historical data and so on.

One or more data storage modules 202 may also be configured to store financial data that is indicative of the financial transactions, whether virtual or real, made through the gaming architecture 100. The financial data is indicative of the fee paid by players, losses, winnings, deposits, withdrawals, bonuses, referrals or any other type of financial transactions made.

It is to be appreciated here that such various categories of data may be stored in a single data storage module, or may be stored in multiple data storage modules, without deviating from the scope of the invention. Such multiple data storage modules may be co-located or distributed geographically. Further, some of these multiple data storage modules may be proprietary of third parties such as banks, fraud units, performance tracking platforms, betting platforms or the like.

One or more input/output modules 203 may include any interface commonly used to communicate with or operate the central gaming system 101, such as a display, keyboard, mouse, joystick, touchpad, microphone, camera, speakers, haptic device or other input-output techniques well known in the art. The central gaming system 101 may also be configured to be operated remotely through any communication network, including, but not limited to, the communications network 102.

One or more memory modules 204 may include any volatile and/or non-volatile memory such as, but not limited to, RAM, ROM, flash memory or the like well-known in the art.

One or more networking interface 205 may be any physical and/or virtual networking interface, known in the art, configured to facilitate communication of the central gaming system 101 with the plurality of gaming terminals 103 through the communications network 102.

One or more internal networking module 206 may be any physical and/or virtual networking interface, known in the art, configured to facilitate communication between various components or modules of the central gaming system 101.

At least one matchmaking module 207 may be configured to identify potential matches, as opponents and/or teammates, for players intending to play an instance of a virtual game.

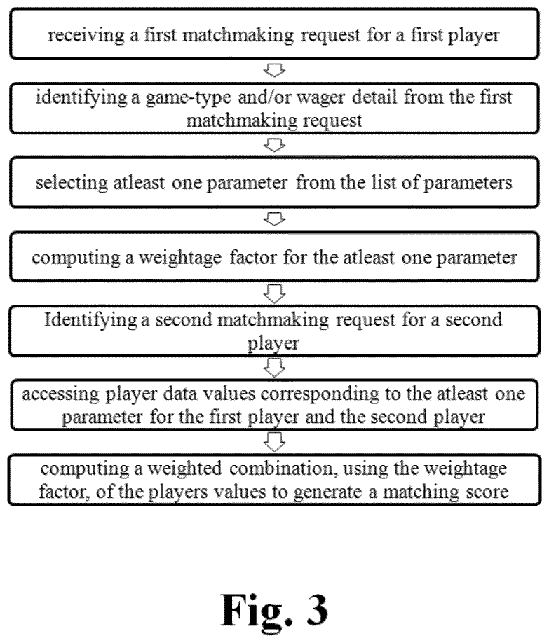

Referring now to FIG. 3, there is shown a method of generating intelligent matches, according to some implementations of the present invention.

At any instance, there exists a plurality of players intending to play a multiplayer online game, through their respective player terminals 103 which are in communication with the central gaming system 101 through the communications network 102. Each of these players may make a request to play the game through their respective player terminals 103 which transmits these requests to the central gaming system 101. Any such request may include data corresponding to a player's identity, a requested game-type and lobby details, among others. The game-type may identify the type and/or the category of the game, such as but not limited to, board game, card game etc. The game-type may also identify the specific type of game, such as but not limited to, poker, rummy, carom or the like. The lobby details may correspond to the fee paid by a player to participate in a game. The lobby details may also be indicative of the amount involved in financial transactions (real or virtual), including any in-game purchases, proposed or required to be made by the player during the gameplay.

At the central gaming system 101, each of these requests may be routed to the matchmaking module 207 for setting up potential matches between the plurality of players. The requests may be time-stamped in order for the matchmaking module 207 to process them linearly (FIFO), or the matchmaking module 207 may gather a plurality of requests for batch processing. In some implementations, the matchmaking module 207 may be configured to gather a minimum number of requests. In other implementations, the matchmaking module 207 may be configured to wait for a required time to gather the requests. In still other implementations, the matchmaking module 207 may be configured to dynamically adjust between linear or batch processing.

At the matchmaking module 207, each received request is processed and the data accompanying the request is identified. The matchmaking module, when processing each matchmaking request, may categorize each such request according to at least one of the game-type and/or the lobby details. As such, every request gets categorized by game-type (such as poker, rummy, racing etc.) and/or lobby details (free to play, higher fee, more and/or costlier in-game purchases etc). In any such category, the matchmaking module 207 collates all respective requests in order to process the same.

In an embodiment of the invention, the matchmaking module 207 identifies, for each request in a category, a player ID from the data accompanying the request. Corresponding to each player ID, the matchmaking module 207 may retrieve a player profile from one or more data storage modules 202. The matchmaking module 207 may process each player profile and identify at least one proposed match. The at least one proposed match consists of a plurality of players that are selected to play together in a single instance of the game. at least one proposed match may be of the type 1vs1, 2vs2, 3vs3 and so on. Also, at least one proposed match may be of the type where the plurality of players all play as opponents, such as in games like rummy, poker, carom, or the like.

In order to identify at least one proposed match, the matchmaking module 207 may process the players' profiles and identify the players' skill level, preferences and/or historical data. The historical data may comprise any data arising out of the interaction of the player with the central gaming system 101. The historical data may correspond to player's statistics parameters such as, but not limited to, player's skill score, win loss tally, recent results, overall points won/lost, recent points won/lost, opponent's skill score, opponent's game score, no. of games played, no. of games played in a time interval, overall games played, time spent or coins/money spent/earned, platform use age, game-time/game, time lapse between games, quits/surrenders frequency, game lobby played and/or game mode, or the like. In addition, the historical data may also indicate the geographic location data and/or the demographic data of the players.

The matchmaking module 207 may be configured to identify a weightage value corresponding to each parameter reflected in the historical data.

The weightage values may be stored in one or more data storage modules 202, or be dynamically computed in real time. The weightage values may be sensitive to multiple factors, such as but not limited to, time of the day, number of matchmaking requests, expected number of matchmaking requests, concurrency, recent matches made, geographic and/or demographic attributes, or the like.

Matchmaking module 207 may, corresponding to the identified game type and/or lobby details, be configured to select at least one parameter from the list of the player's statistics parameters and historical data. Alternatively, or in addition, the matchmaking module may be configured to identify a weightage value corresponding to each selected parameter.

In the next steps, the matchmaking module 207 may access the historical data for a first player and a second player from the respective player profiles stored in one or more data storage modules 202 to identify a first player values and a second player values corresponding to each of the selected parameters.

Matchmaking module 207 may be configured to combine the first player values with the second players using the identified weightage values corresponding to each selected parameter, to generate a matching score.

In an exemplary application, the matchmaking module 207 may be configured to compare the matching score with a threshold value. In case the matching score is higher than the threshold value, the matchmaking module 207 may instruct one or more processor modules 201 to initiate, for the first player and the second player, a first instance of the virtual game. In case the matching score is lower than the threshold value, the matchmaking module 207 may be configured to select a third matchmaking request and to generate a new matching score corresponding to the first matchmaking request and the third matchmaking request.

Alternatively, or in addition, the matchmaking module 207 may be configured to compute matching scores corresponding to a plurality of pairs of matchmaking requests collated under a single category. Matchmaking module 207 may then process these matching scores by employing various optimizing techniques and algorithms to identify at least one proposed match. Alternatively, the matchmaking module may also identify at least one proposed match randomly.

The disclosure is operational with numerous other general purpose or special purpose computing system environments or configurations. Examples of well-known computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, and distributed computing environments that include any of the above systems or devices, and the like.

As used herein, the wording “module” serves only as a representation of the functional aspect, and should not be construed as limiting to only physical or tangible systems or components.

1. A method of matching players requesting to play a virtual game, the method comprising:
receiving a first request from a first player, the request signalling an intent of the first player to play the virtual game;
identifying a first game type from the first request;
corresponding to the identified game type, selecting at least one parameter from a list of parameters, the list of parameters corresponding to historical records of players playing the virtual game;
identifying a weightage factor for the at least one parameter;
identifying a second request made by a second player received asynchronously from the first request;
accessing player data values corresponding to the at least one parameter for the first player and the second player;
combining player data values corresponding to the at least one parameter for the first player with those of the second player to yield a matching score, wherein the combination is a weighted combination using the weightage factor for the at least one parameter.

2. The method according to claim 1, wherein, in case the matching score is above a threshold value, initiating, for the first player and the second player, a first instance of the virtual game.

3. The method according to claim 2, wherein, in case the matching score is not above the threshold value, identifying a third request made by a third player received asynchronously from the first request.

4. The method according to claim 2, wherein the threshold value is calculated based on the time elapsed since receiving the first request.

5. The method according to claim 1, wherein:
corresponding to each of a plurality of pairs of matchmaking requests, computing a matching score; and
optimizing the plurality of matchmaking scores to identify at least one proposed match.

6. The method according to claim 1, wherein the matching score is indicative of the probability of winning for the first player.

7. The method according to claim 1, wherein the matching score is indicative of the level of engagement of the first player.

8. The method according to claim 1, wherein the weightage factor for the at least one parameter is computed based on at least one of time of the day, number of matchmaking requests, expected number of matchmaking requests, concurrency, and/or recent matching scores.

9. A system comprising:
one or more processing modules;
one or more data storage modules, operatively coupled to the one or more processing modules, wherein the one or more data storage modules are configured to store at least one of:
a list of parameters corresponding to historical records of players playing the virtual game; and
player data values corresponding to the list of parameters;
at least one memory module operatively coupled to the one or more processing modules, wherein the at least one memory module stores instructions which, when executed by the one or more processing modules, causes the one or more processing modules to,
identify a game type from a first matchmaking request made by first player;
corresponding to the identified game type, select at least one parameter from a list of parameters;
identify a weightage factor for the at least one parameter;
identify a second request made by a second player;
access player data values corresponding to the at least one parameter for the first player and the second player;
combine player data values corresponding to the at least one parameter for the first player with those of the second player to yield a matching score, wherein the combination is a weighted combination using the weightage factor for the at least one parameter.

10. The system according to claim 9, wherein the one or more processing modules computes the weightage factor for the at least one parameter based on at least one of time of the day, number of matchmaking requests, expected number of matchmaking requests, concurrency, and/or recent matching scores.
